(19) United States
(12) Patent Application Publication
(10) Pub. No.: US 2002/0108404 A1
(43) Pub. Date: Aug. 15, 2002

(54) Drying agent and improved process for drying soot preforms

(76) Inventors: Gerald E. Burke, Painted Post, NY (US); Lisa F. Chang, Wilmington, NC (US); Steven B. Dawes, Corning, NY (US); Gary P. Granger, Painted Post, NY (US); Michael T. Murtagh, Horseheads, NY (US); Chukwuemeka B. Onuh, Wilmington, NC (US); Susan L. Schiefelbein, Corning, NY (US); Jeanne L. Swecker, Wilmington, NC (US); Ji Wang, Painted Post, NY (US); Joseph M. Whalen, Corning, NY (US)

Correspondence Address: CORNING INCORPORATED, SP-TI-3-1, CORNING, NY, 14831

(21) Appl. No.: 09/967,621

(22) Filed: Sep. 27, 2001

Related U.S. Application Data
(63) Continuation-in-part of application No. 09/671,790, filed on Sep. 27, 2000.

(51) Int. Cl. C03B 37/018; C03B 32/00

(52) U.S. Cl. 65/422; 65/426; 65/32.1

(57) ABSTRACT

The disclosed invention includes an inventive drying agent. The drying agent includes at least one halide and at least one reducing agent. Preferably, the reducing agent includes a compound that will react with an oxygen by-product of the reaction of the halide and water, or the reaction of the halide and an impurity in the preform. The invention also includes a method of drying a soot preform. The method includes disposing the soot preform in a furnace. The furnace is charged with the drying agent which includes the halide and the reducing agent. Heat is then supplied to the furnace. Suitable drying agents for use in the disclosed invention include a mixture of Cl₂ and CO; a mixture of Cl₂, CO and CO₂; and POCl₃.

### CROSS-REFERENCE TO RELATED APPLICATIONS

This application is a continuation-in-part of U.S. patent application Ser. No. 09/671,790, filed Sep. 27, 2000 and entitled “DRYING AGENT AND IMPROVED PROCESS FOR SOOT PREFORMS,” the content of which is relied upon and incorporated herein by reference in its entirety.

### BACKGROUND OF THE INVENTION

1. Field of the Invention

The present invention relates generally to the manufacturing of a soot preform, and particularly to a drying agent for the soot preform and methods to dry the soot preform.

2. Technical Background

In the manufacturing of optical fibers (hereinafter “fiber”) and other products which can be produced from a soot preform, a preform having numerous impurities may cause various defects in the final product. For example, a fiber that includes an inordinate amount of water will have a high attenuation. Furthermore, the presence of other elements or molecules, for example H, O, OH, or combinations thereof, may lead to the formation of water in the final product and result in a fiber with high attenuation.

In an effort to remove water or water deriving elements from a preform, the preform is dried. Traditionally, the preform is disposed in a drying furnace prior to consolidation. The furnace is charged with a helium gas stream which includes approximately two percent (2%) chlorine (Cl₂). The furnace is heated to a temperature of approximately 1000° C. for up to about two (2) hours. The chlorine reacts with a water molecule to form hydrochloric acid and oxygen according to the following reaction:

H₂O+Cl₂→2HCl+1/2O₂.

The preform is then consolidated and either drawn into an optical fiber or made into another product.

The exposure to chlorine gas is also beneficial in that it removes metal oxide impurities such as zirconia, chromia, titania, etc. from the soot preform. The chlorine reacts with the metal in a metal oxide molecule to form a metal chloride, and oxygen is formed as a by-product according to the following reaction:

ZrO₂+2Cl₂→ZrCl₄+O₂.

The preform is then consolidated and drawn into an optical fiber.

### SUMMARY OF THE INVENTION

One embodiment of the present invention is a soot preform drying agent. The drying agent includes at least one halide and at least one reducing agent. Preferably, the reducing agent includes a compound or element that will react with the oxygen by-product of the reaction of the halide and water, or the reaction of the halide and another impurity in the preform.

In another embodiment, the present invention includes a method of drying a soot preform. The method includes disposing the soot preform in a furnace. The furnace is charged with a drying agent which includes the halide and the reducing agent. Heat is then supplied to the furnace.

Practicing the invention will result in the advantage of adjusting the chemical reaction equilibrium of the water or the impurity with the halide to remove more of the water or the impurity from the soot preform than in the case of a halide only drying agent. Another advantage of practicing the invention is that the inventive drying agent may be used to treat a soot preform over a wider range of temperatures than a traditional chlorine treatment of the preform. These advantages will correspond with the production of a drier preform from which to draw an optical fiber or manufacture another product.

A further advantage of practicing the invention is that impurities such as water, hydrogen, oxygen, hydroxyl groups, metal oxides, and alkali metal oxides are removed from the soot preform. The removal of the impurities from the soot preform will eliminate fiber breaks which are attributed to the presence of the impurities. In addition to fewer fiber breaks, the fiber will be drawn from a drier preform. Drawing fiber from a drier preform will result in an optical fiber with decreased attenuation.

An additional advantage of practicing the invention is that any residual amount of the reaction products of the reaction between the inventive drying agent and the compound to be reduced are stable compounds that are both chemically and optically inert in the drawn fiber product. Furthermore, the invention has the advantage that it can be used to dry multi-component fiber compositions, e.g. a fiber composition which includes SiO₂—Na₂O—Al₂O₃.

Another advantage of practicing the present invention is that the inventive drying agents are much more active at low temperatures than traditional chlorine drying agents, allowing soots with lower melting temperatures to be dried efficiently without premature sintering.

The invention has an excellent application to produce an improved 157 nm photomask plate. The enhanced drying techniques may be used to remove water and impurities from a soot preform which can be used to manufacture a photomask plate. The resulting photomask plate will exhibit low water and low metal content.

Additional features and advantages of the invention will be set forth in the detailed description which follows, and in part will be readily apparent to those skilled in the art from the description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a cross sectional schematic view of a preform in a furnace in accordance with the invention.

FIG. 2 is a partial cross sectional schematic view of a consolidated preform being drawn into an optical fiber.

FIG. 3 is a partial cross sectional schematic view of a soot coated core cane in furnace in accordance with the invention.

FIG. 4 is a graph of attenuation vs. draw tension at a wavelength of 1310 nm exhibited by a fiber made in accordance with the invention and a control fiber.

FIG. 5 is a graph of attenuation vs. draw tension at a wavelength of 1550 nm exhibited by a fiber made in accordance with the invention and a control fiber.

FIG. 6 is a graph of attenuation vs. wavelength exhibited by an erbium-doped phosphosilicate fiber made in accordance with the present invention.

FIG. 7 is a graph of fluorescence vs. wavelength exhibited by an erbium-doped phosphosilicate fiber made in accordance with the present invention, and an erbium-doped phosphosilicate fiber made using standard methodology.

### DETAILED DESCRIPTION OF THE INVENTION

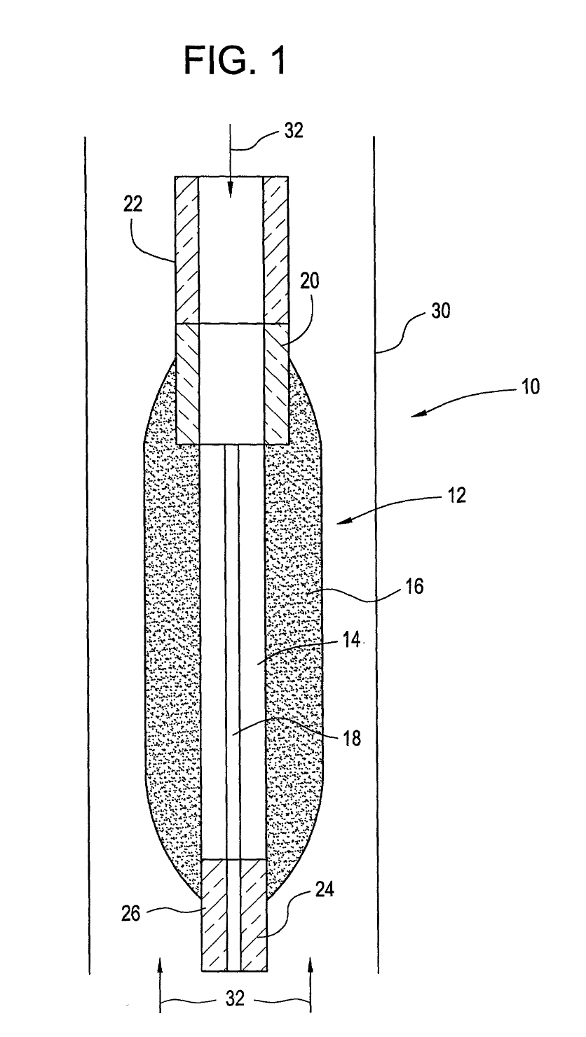

Reference will now be made in detail to the present preferred embodiments of the invention, examples of which are illustrated in the accompanying drawings. Wherever possible, the same reference numbers will be used throughout the drawings to refer to the same or like parts. An embodiment of the method of drying a soot preform and the drying agent of the present invention is shown in FIG. 1, and is designated generally throughout by reference numeral 10.

In accordance with the invention, the inventive soot preform drying agent includes at least one halide and a reducing agent. Preferably, the drying agent is a compound or combination of compounds that will react with water or another impurity to form a more stable compound or compounds than the water or the other impurity. The invention is not limited to the aforementioned definition. Preferably, the reducing agent includes a compound that will preferentially react with an oxygen by-product of the chemical reaction

aMₓO_{y}+bX₂→cMᵢXⱼ+dO₂.

The coefficient “a” is the stoichiometric coefficient of a compound desired to be reduced, MₓO_{y}. The symbol “M” is used to define a metal, hydrogen, or an alkali metal. Typical metals that may be found as impurities in a soot preform include, but are not limited to, iron, chromium, zirconium, nickel, and titanium. The alkali metals include lithium, sodium, potassium, rubidium, and cesium. In the case that the halide is reacting with a metal or alkali metal, the drying agent may also be known as a stripping agent or a cleansing agent. The coefficient “b” is the stoichiometric coefficient of a halide “X”. The preferred halides which may be a part of the drying agent include fluorine, chlorine, bromine, and iodine. The coefficient “c” is the stoichiometric coefficient of a reaction product of the reaction of the halide “X” and “M”. The coefficient “d” is the stoichiometric coefficient of an oxygen by-product of the reaction. The letters x, y, i, and j are numbers greater than zero. It is also preferred that the reducing agent is not a halide. In the case that M is a metal, the drying agent may also be referred to as a stripping agent.

In an embodiment of the drying agent, the halide may be combined with the reducing agent to form a single compound. Optionally, the drying agent may consist of a mixture of at least two separate compounds, in which one compound contains a halide and a second compound contains the reducing agent. Preferably, when the drying agent is composed of two or more compounds, the drying agent includes a halide, X, in the form of X₂ as previously stated. Another suitable embodiment of the two compound drying agent includes a compound containing at least one halide and a reducing agent containing compound. An example of a suitable halide containing compound is COCl₂. Optionally, the drying agent may also include at least one inert gas, e.g. He, Ar, or N₂.

Preferably the reducing agent has one of the following general formulas I, II, or III:

R (I)

RO; (II)

or

SO₂. (III)

“R” is an element selected from the group consisting of C and P.

Preferred drying agents include a compound that is selected from the group consisting of COXₙ, SO₂Xₙ, PXₙ, and POXₙ. “X” is a halide selected from the group consisting of F, Cl, Br, I, or mixtures thereof. The symbol “n” is an integer ranging from 1-5. A more preferred drying agent is a gaseous mixture of Cl₂+CO, Cl₂+CO/CO₂ or mixtures thereof. The gases Cl₂, CO, and CO/CO₂ are available from Airgas of Radnor, PA. CO/CO₂ is a mixture of carbon monoxide (CO) and carbon dioxide (CO₂). In the case of CO/CO₂, it is preferred that the amount of CO₂ present is greater than the amount of renegade O₂ present. Renegade O₂ is the sum of that O₂ that is contained as trace materials in the drying agent gas or inert gas, that O₂ that enters the furnace due to leakage, and that O₂ present in ambient conditions in the furnace. In a preferred embodiment, the mole ratio of CO to CO₂ is at least about 100:1.

In an embodiment of the invention, the soot may include at least one dopant. Preferred dopants include index of refraction increasing dopants, e.g. germanium or titanium, or index of refraction lowering dopants, e.g. fluorine or boron. The invention is not limited to the four potential dopants mentioned above. It is preferred that the dopant is more stable than the product of the reducing agent and oxygen. For example, if the dopant is GeO₂ and the reducing agent is CO, it is preferred that the equilibrium of the reaction of GeO₂₍ₛ₎+CO⇄GeO₍ₛ₎+CO₂ has a ΔG^{rxn} that is positive. Alternatively, the reaction between the reducing agent and the oxygen should have a more negative ΔG^{rxn} than the ΔG^{rxn} of the reaction between the dopant and the reducing agent.

In comparing the reaction kinetics, it is preferred that the reaction kinetics of the reaction between the dopant and the drying agent is slower than the reaction between the drying agent and the compound desired to be reduced. Therefore, it is desired that the drying agent preferentially reacts with the compound desired to be reduced instead of the dopant.

In the case that the soot contains a dopant, it is preferred that the amount of drying agent used to dry the preform is controlled. Excess drying agent can react with an oxided dopant compound of the preform, such as the previously stated reaction of CO and GeO₂. The reaction between the dopant and the drying agent is not preferred. It is preferred that the drying agent is incorporated into the manufacturing in a manner not to promote the reaction between the dopant and the drying agent.

Preferably, the drying agent includes up to about one mole of the reducing agent for every mole of the halide. It is more preferred that the drying agent includes less than about one mole of the reducing agent for every mole of the halide.

As embodied herein, and depicted in FIG. 1, the invention includes a method of drying a soot preform 12. Soot preform 12 may be formed from any known technique to form a soot body. These techniques include, but are not limited to, outside vapor deposition (OVD), vapor axial deposition (VAD), modified chemical vapor deposition (MCVD), plasma chemical vapor deposition (PCVD), or any other known technique, such as sol-gel processing.

Preform 12 has a core 14 and a cladding 16. Optionally, preform 12 may have a near cladding (not shown). Core 14 is typically composed of a doped silica. Preferably core 14 is doped with germanium to increase the refractive index of core 14. Optionally, core 14 may also include a second dopant such as fluorine or more preferably an annular fluorine doped portion. Core 14 has a center passage 18. Cladding 16 is disposed around core 14. Cladding 16 is typically silica. Cladding 16 will have a lower refractive index than the refractive index of core 14. The invention is not limited to the aforementioned materials of construction for core 14 and cladding 16.

Preform 12 shown in FIG. 1 is a core cane preform, meaning that the preform may be drawn into a core cane. The invention is not limited to a core cane preform; the invention may also be practiced on a preform which consists of a soot cladded core cane. The soot cladded core cane is also known as an overcladded preform or an overcladded core cane.

Preferably, preform 12 has a handle 20 that is fused to a standard ball joint handle 22. A plug 24 with an optional capillary tube 26 is disposed at an end of core 14 opposing handle 20.

Preform 12 is suspended in a furnace 30. Furnace 30 is charged with a gas that flows in the direction of arrows 32. The gas contains the drying agent. The drying agent is a gas that contains the halide and the reducing agent. Preferably the gas includes an inert material such as helium, nitrogen, argon, or mixtures thereof. The present invention is not limited to only the listed inert material. The halide may be present in the drying agent in a pure form or as an element of a compound. However, if the halide is present in the form of a compound, the reaction between the halide and water or the impurity must be favorable. Likewise, the reducing agent may be present in the drying agent in its pure form or as an element of a compound with the same caveat as the halide. For example, the halide may be present in the form of hydrochloric acid or germanium tetrachloride. The reaction of the germanium tetrachloride with water would be a favorable reaction, whereas, the reaction of hydrochloric acid and water is not a favorable reaction.

GeCl₄+2H₂O⇄4HCl+GeO₂

HCl+H₂O⇄HCl+H₂O

A favorable reaction is a reaction which has a ΔG^{rxn} that is negative or in the case of competing reactions, the favorable reaction is the reaction with a more negative ΔG^{rxn}.

The gas may be charged into furnace 30 during a drying operation of preform 12 or during consolidation of preform 12. In the case that furnace 30 is charged during a drying phase, preform 12 is heated to a drying temperature of about 1000 to about 1200° C., inside furnace 30. Preferably, preform 12 is heated to about 1100 to about 1200° C. Preform 12 is maintained at the drying temperature for a period of about one (1) to about four (4) hours. It is preferred that furnace 30 is maintained at the drying temperature for about four (4) hours. Practicing the invention will result in drier preforms (a.k.a. blanks) which a fiber may be drawn from. In selecting a particular drying temperature for removing water from the preform, preferably a temperature is chosen at which kinetics of gas-solid reactions are sluggish, but kinetics of gas-gas reactions (i.e. the drying reaction) are fast.

During the drying process, the halide will react with a hydrogen element or a hydrogen associated with a water molecule or a hydroxyl molecule. The halide may also react with the metal ion of a present metal oxide or the alkali metal ion of a present alkali metal oxide in the soot. The reducing agent will react with the oxygen by-product of the reaction with the halide. The reaction between the reducing agent and the oxygen by-product will shift the chemical equilibrium of the halide reaction, such that the halide will react with more of the hydrogen ion, metal ion, or alkali metal ion, as desired. Consequently, more water or other impurities are reacted away from the soot preform than by traditional drying techniques. This shifting of the chemical equilibrium may also be phrased in terms of reducing the partial pressure of oxygen in the reaction between the halide and the compound to be reduced.

The use of the above drying agent is not limited to temperatures above 1000° C. The drying agent may be used at temperatures below 1000° C. The drying agent of the invention may be used to remove impurities from a preform at temperatures as low as about 200° C., preferably 700° C. or less. In selecting a minimum drying temperature, the one factor that must be examined is process time. Generally, the lower the drying temperature, the greater the time period the drying process requires. Furthermore with respect to temperature, the inventive drying agent may be used to dry a preform at temperatures above about 1600° C., for a glass composition that would sinter at temperatures above about 1600° C.

There are potential advantages from drying at a lower temperature. One example is drying a silica (SiO₂) preform doped with germanium oxide (GeO₂). Drying at a high temperature can result in a significant loss of the dopant for at least the reason that at higher temperatures the germanium (Ge) may react with a halide and volatilize off. In accordance with the invention, the gas-solid reaction of Ge and the halide is more sluggish at a lower temperature. Therefore the probability of the Ge volatilizing is reduced.

After drying preform 12, optionally center passage 18 is closed and the preform is consolidated. One technique to close passage 18 is applying vacuum to center passage 18. To consolidate perform 12, the drying agent is discharged from furnace 30 and furnace 30 is heated to a temperature of about 1400 to about 1600° C. It is preferred that consolidation occurs in an inert atmosphere, for example, helium. A suitable period of time for preform 12 to consolidate is about one (1) to six (6) hours. In a preferred embodiment, the consolidation time is four (4) to six (6) hours. However, the consolidation period may vary depending on the consolidation temperature, the size and density of the preform, and the chemical composition of the preform. Consolidation may occur in the same furnace as drying or a different furnace.

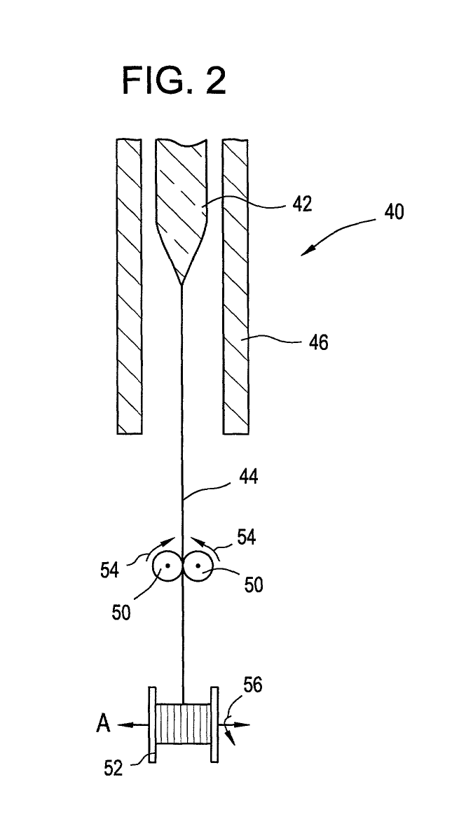

As shown in FIG. 2, designated reference numeral 40, consolidated preform 42 may be drawn into fiber 44. Consolidated preform 40 is heated to a temperature of about 1800° C. or more and drawn into a fiber. Preferably, consolidated preform 40 is transported to a draw furnace of drawing preform 40 into the fiber. It is preferred that a muffle 46 is disposed at an exit of the consolidation furnace. Fiber 44 is pulled by tractors 50 and stored on a spool 52. Tractors 50 rotate in the direction arrows 54. Spool 52 rotates in the direction of arrow 56 around axis A. Typical draw rates are 20 m/s or more.

In another embodiment, the drying may take place during consolidation. In this embodiment, the drying gas is charged into furnace 30 and the furnace is heated to the aforementioned consolidation temperature range.

An additional embodiment of the invention includes depositing soot onto a core cane. The soot deposited onto the core cane, preferably, should have a refractive index that is equal to or less than the refractive index of the core region of the core cane. It is preferred that the refractive index of the soot is less than the refractive index of the core region of the core cane. An example of a preferred material deposited on the core cane is silica (SiO₂). The silica may be doped with a refractive index increasing dopant or a refractive index decreasing dopant. The soot coated core cane may be referred to an overcladded core cane or an overcladded preform.

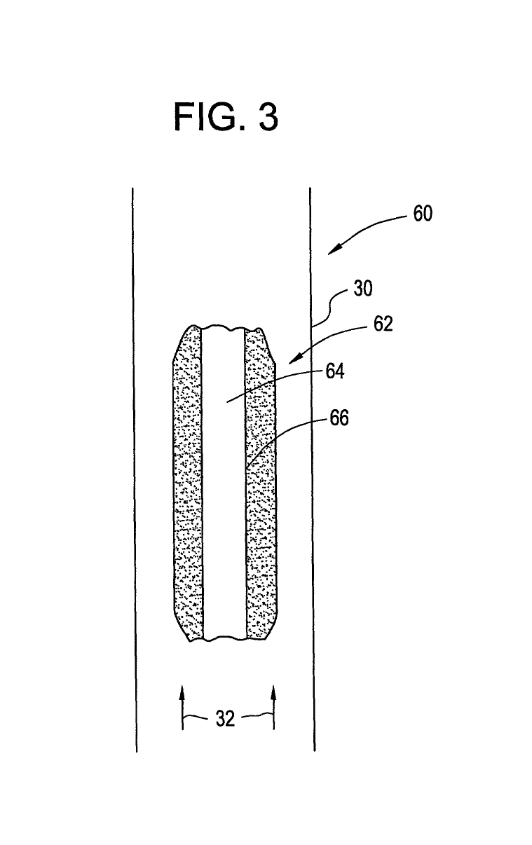

Depicted in FIG. 3, and generally designated by reference numeral 60, is an overcladded preform 62. Overcladded preform 62 consists of a core cane 64 and soot 66. Preform 62 is exposed to the aforementioned atmosphere 32 in a furnace 30 for a period of about 1 to about 6 hours at a temperature of about 700 to about 1600° C.

It is preferred that the draw blank is exposed to the gas mixture before sintering. One preferred set of reaction parameters include a gas mixture including up to about 10 weight percent of CO and up to about 10 weight percent of Cl₂. A draw blank as used herein is meant to describe a preform that may be placed into a furnace and drawn into an optical fiber. Preferably, the furnace is heated to a temperature between about 900 to about 1200° C., more preferably to about 1125° C. The draw blank is treated with the gas mixture for preferably about 1 to about 4 hours. Optionally, the gas mixture is discharged from the furnace. The overcladded core cane is then sintered into a draw blank. The draw blank is preferably transported to a draw furnace and drawn into an optical fiber.

The invention will also minimize the effect of heat aging on the drawn fiber. The presence of excess oxygen (O₂) in the furnace during consolidation contributes to the heat aging of GeO₂ doped SiO₂ fiber. Practicing the invention will reduce the amount of oxygen in the preform and consequently, in the consolidated glass. This is for at least the reason that during the drying process the drying agent will react with the O₂ by-product formed during the drying reaction to form an optically and chemically inert compound. Consequently, with less O₂ present during consolidation, the drawn fiber will exhibit improved heat aging.

An optical fiber made in accordance with the invention may be drawn into a low loss fiber. The fiber may have an attenuation of less than about 0.34 dB/km at a given operating wavelength between about 1300 to about 1320 nm, preferably at about 1310 nm. Preferably, the fiber has an attenuation less than about 0.21 dB/km at an operating wavelength between about 1300 to about 1600 nm, especially at a wavelength of about 1550 nm. More preferably the fiber has an attenuation of 0.195 dB/km or less.

The fiber also has an improved attenuation at the water peak. The fiber has a demonstrated attenuation of less than about 0.4 at a given wavelength in between about 1375 to about 1390 nm. More preferably, the fiber has a demonstrated attenuation less than about 0.35.

In another embodiment of the invention, a soot preform with a relatively low melting temperature may be dried efficiently at temperatures greater than 600° C. For example, erbium-doped phosphosilicate fibers cannot be adequately dried using conventional chlorine drying techniques, because the phosphosilicate soot would sinter at the relatively high temperatures required for chlorine drying. As the skilled artisan will appreciate in light of the present disclosure, the low-temperature drying process described herein may be used advantageously with any soot preform that would sinter at conventional chlorine drying temperatures of 1000-1200° C.

Phosphorus oxychloride (POCl₃) may be used in accordance with the present invention to dry soot preforms in a low-temperature drying process. POCl₃ is a single compound drying agent that contains chlorine as the halide, and PO as the reducing agent, and has a boiling point of about 106° C. The reaction of POCl₃ with water has a much higher equilibrium constant than does the reaction of Cl₂ with water. Consequently, POCl₃ is thermodynamically much more efficient at removing water than is Cl₂. The hydrolysis of POCl₃ is likewise kinetically faster than the hydrolysis of Cl₂.

Phosphorus oxychloride gas may be introduced into the drying gas mixture by a bubbler. For example, a 1500 mL bubbler from Arch Chemicals may be operated at 55° C. with argon as the carrier gas. The concentration of the POCl₃ in the drying gas may be varied by the skilled artisan to effect the desired amount of drying. The concentration of POCl₃ in the vapor is usually in the range of 0.2% to 4% by volume. For example, flows of POCl₃ from the bubbler may be between about 12 and 24 sccm, in a total drying gas mixture flow between about 1000 and 2000 sccm. The drying gas mixture may flow along the outside of the soot preform, and may also flow through the center passage of the preform, as shown above in FIG. 1.

Phosphorus oxychloride is suitably used as a drying agent at temperatures above 600° C., and more preferably at temperatures between about 800° C. and about 1000° C. The reaction of water in a soot preform with POCl₃ will yield phosphorus species such as P₂O₅ and HPO₃. These by-products are volatile at temperatures above 600° C., and will generally be removed as vapor in the drying gas mixture. However, at higher concentrations of POCl₃, some phosphorus may be doped into the soot blank. Thus, high concentrations of POCl₃ in the drying gas mixture may be used to adjust phosphorus doping levels as well as to remove water from the soot preform.

In the manufacture of highly doped optical fibers such as erbium-doped phosphosilicate fiber, it may be desirable to include molecular chlorine (Cl₂) into the drying gas mixture. While Cl₂ does not react efficiently with water below 1000° C., it is effective at stripping undesired metals such as iron and zirconium from the preform, thus reducing the amount of particulate impurities in the optical fiber.

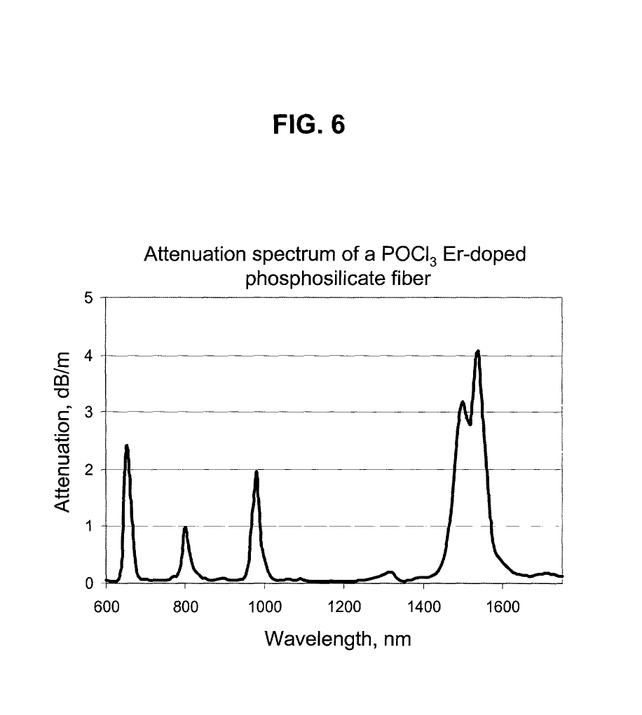

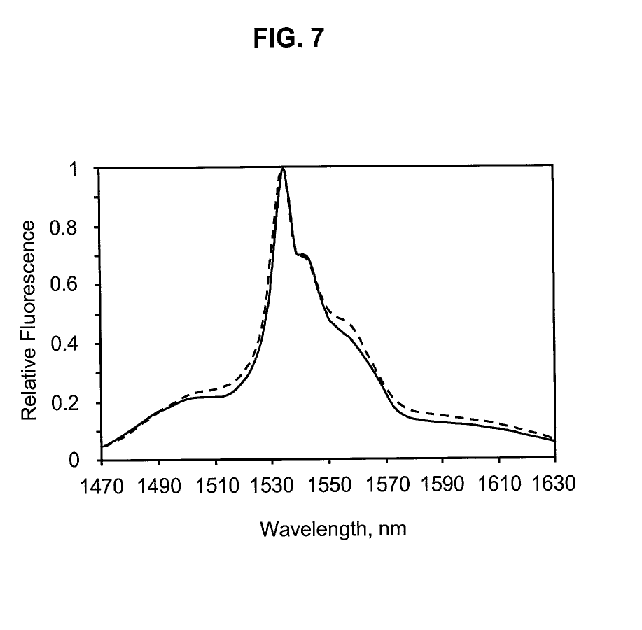

After drying with POCl₃, the soot preform may be consolidated and drawn into optical fiber using methods familiar to the skilled artisan. Erbium-doped phosphosilicate optical fibers dried with POCl₃ have low background losses, as shown in FIG. 6. Erbium-doped phosphosilicate optical fibers dried with POCl₃ also have narrower erbium fluorescence spectra than conventionally made erbium doped phosphosilicate fibers, as is shown in FIG. 7.

The invention is not limited to the production of a preform for an optical fiber. The invention also has an excellent application in the manufacturing of a photomask preform, especially a photomask that may utilize vacuum ultraviolet light wavelengths of 193 nm and below and preferably wavelengths in the region of 157 nm.

Like an optical fiber, a photomask substrate may also be produced from a soot preform. A distinction between the photomask preform and the optical fiber preform is that the photomask preform is a tube. The photomask preform may be formed by any of the chemical vapor deposition techniques already described. The photomask preform is further dried and consolidated in a similar manner as the optical fiber preform. For additional background on a photomask glass and the production of such glass U.S. patent applications Ser. No. 09/397,577, filed Sep. 16, 1999, Ser. No. 09/397,573, filed Sep. 16, 1999, and Ser. No. 09/397,572, filed Sep. 16, 1999 are incorporated herein in their entirety.

In the case of a photomask preform, it is advantageous to remove water and any other metal impurities from the preform before consolidation. The use of the inventive drying agent is a technique to improve the drying of the photomask preform. Similar to an optical fiber preform, the photomask preform is dried in a furnace in an atmosphere of the inventive drying agent at a temperature of preferably between about 700 and less than about 1400° C., and preferably between about 1000 and 1200° C. The preform is heated for approximately a period of up to four (4) hours, preferably one (1) to three (3) hours, during the drying step. The dried photomask preform is consolidated at a temperature of about 1400 to about 1600° C., preferably 1400 to 1500° C. into a dense glass tube. The preform is heated for a period of one (1) to six (6) hours, preferably four (4) to six (6) hours. During consolidation, the preform may be fluorine doped. The consolidated preform is formed into a photomask substrate. The process of forming the consolidated preform into the photomask substrate is disclosed in U.S. patent applications Ser. Nos. 09/397,577 and 09/397,572, the specifications of which are incorporated herein by reference.

The invention will be further illustrated by the following examples which are not intended to limit the invention.

### EXAMPLE 1

In the example, the attenuation exhibited by fiber drawn from a preform dried in an atmosphere that includes a halide and 200 ppm of CO was compared to the attenuation exhibited by fiber drawn from a preform that was dried in an atmosphere that did not contain CO. The two preforms were dried at a temperature of 1050° C. The drying time period was four (4) hours. Optical fibers were drawn from the preform for testing. The drawn fiber was SMF-28, available from Coming, Incorporated of Coming, N.Y.

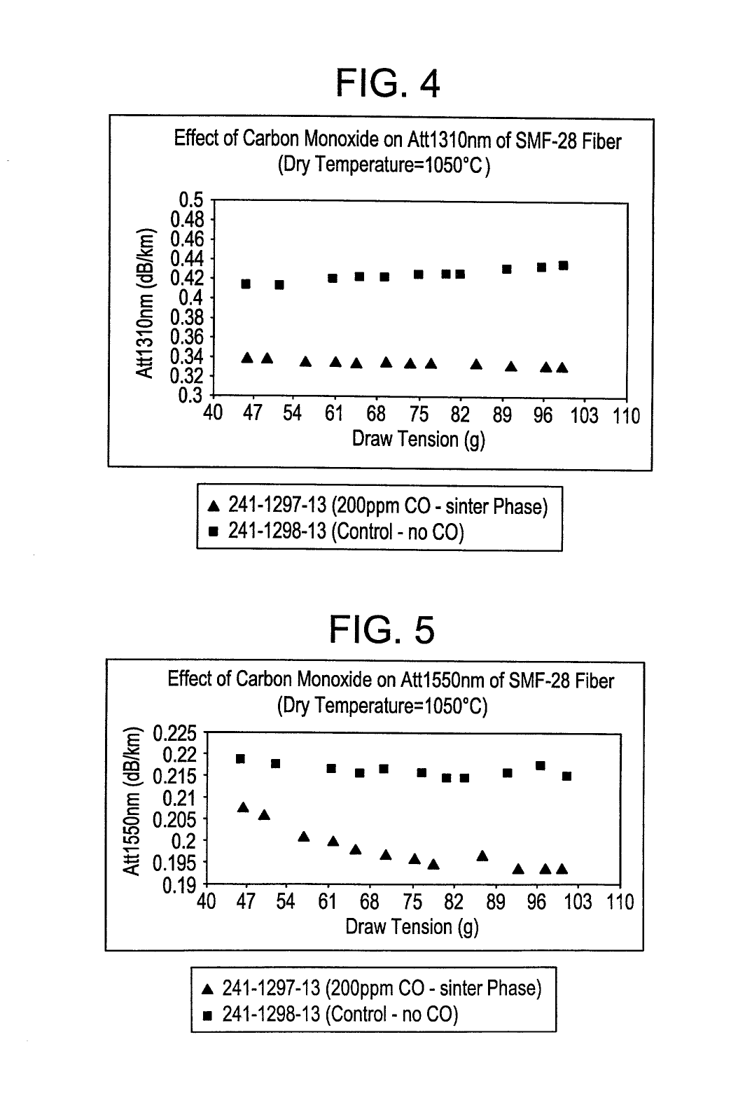

The fiber drawn from the preform dried in an atmosphere that contained CO exhibited a significant reduction in attenuation, approximately 20%. The results of the testing are shown in FIGS. 4 and 5. At the wavelength of 1310 nm, the test fiber exhibited an attenuation of about 0.35 dB/km or less. The control fiber exhibited an attenuation of about 0.42 dB/km or more at the wavelength of 1310 nm. At wavelength of 1550 nm, the test fiber exhibited an attenuation of less than about 0.21 dB/km, preferably less than about 0.195 dB/km. The control fiber exhibited an attenuation of more than 0.215 dB/km at a wavelength of 1550 nmn.

### EXAMPLE 2

A soot preform having a phosphorus-doped silica core layer and a phosphorus and fluorine-doped silica cladding layer is made using outside vapor deposition (OVD) techniques familiar to the skilled artisan. After removal of the bait rod, the preform is held in a furnace, as shown in FIG. 1. The drying gas mixtures and flows are independently controlled in the center passage and the furnace. The soot blank is first preheated for 60 minutes at 850° C. with a 1000 sccm flow of He through the center passage, and a 30,000 sccm flow of He in the furnace. The soot blank is then dried for 60 minutes at 850° C., using a drying gas mixture including 18 sccm POCl₃ (from a 1500 mL bubbler operating at 55° C. with argon as the carrier gas), 200 sccm Cl₂, and 1000 sccm He flowing through the center passage, and the drying gas mixture of 1000 sccm Cl₂ and 30000 sccm He flowing through the furnace. The soot blank is then purified for 60 minutes at 850° C., with a flow of 200 sccm Cl₂ and 1000 sccm He through the center passage, and a flow of 1000 sccm Cl₂ and 30000 sccm He in the furnace. The soot blank may then be consolidated and drawn into fiber using methods familiar to the skilled artisan.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method of drying a soot preform comprising:
disposing the soot preform in a furnace;
charging the furnace with a drying agent comprising at least one halide and at least one reducing agent; and
heating the furnace.

2. The method of claim 1 wherein the reducing agent comprises a compound that will preferentially react with an oxygen by-product of the following chemical equation
aMₓO_{y}+bX₂→cMᵢXⱼ+dO₂
wherein “a” is the stoichiometric coefficient of a compound desired to be reduced, M is a metal, hydrogen, or an alkali metal, “b” is the stoichiometric coefficient of a halide X, “c” is the stoichiometric coefficient of a reaction product of the reaction of said halide X and said M, “d” is the stoichiometric coefficient of an oxygen reaction by-product, x, y, i, and j are greater than 0.

3. The method of claim 2 wherein the reducing agent comprises a general formula I, II, or III:
R (I)
RO; (II)
or
SO₂ (III)
wherein R is an element selected from the group consisting of C and P.

4. The method of claim 3 wherein the drying agent is a compound selected from the group consisting of COXₙ, SO₂Xₙ, PXₙ, POXₙ, and mixtures thereof, wherein X is a halide selected from the group consisting of F, Cl, Br, I, or mixtures thereof, and n is an integer ranging from 1-5.

5. The method of claim 3 wherein said reducing agent is one selected from the group consisting of C, P, CO, CO/CO₂, and mixtures thereof.

6. The method of claim 2 wherein the soot includes a dopant, and a reaction between said reducing agent and said oxygen by-product has a more negative ΔG^{rxn} than a reaction between said dopant and said reducing agent.

7. The method of claim 2 wherein said drying agent is one selected from the group consisting of Cl₂+CO, Cl₂+CO/CO₂, and mixtures thereof.

8. The method of claim 1 wherein said halide is chlorine.

9. The method of claim 1 wherein the reducing agent comprises CO.

10. The method of claim 1 wherein the reducing agent comprises CO/CO₂.

11. The method of claim 7 wherein said heating comprises raising the temperature inside the furnace to within a range from about 700 to about 1600° C.

12. The method of claim 11 wherein said heating step is for a duration of up to 4 hours.

13. The method of claim 11 further comprising consolidating the soot preform and drawing the preform into an optical fiber.

14. The method of claim 13 wherein said consolidating occurs at a temperature of about 1400 to about 1600° C.

15. The method of claim 11 further comprising discharging the drying agent from the furnace and then consolidating the preform.

16. The method of claim 15 further comprising drawing an optical fiber from the preform.

17. The method of claim 11 further comprising drawing the preform into a core cane.

18. The method of claim 1 wherein said charging comprises flowing the gas through an aperture of the preform.

19. The method of claim 1 wherein the soot preform comprises an optical fiber preform.

20. The method of claim 1 wherein the soot preform comprises a photomask preform.

21. The method of claim 1 wherein the drying agent comprises POCl₃.

22. The method of claim 21 wherein the drying agent further comprises Cl₂.

23. The method of claim 21 wherein said heating comprises raising the temperature inside the furnace to above about 600° C.

24. The method of claim 23 wherein said heating comprises raising the temperature inside the furnace to within a range from about 800 to about 1000° C.

25. The method of claim 21 wherein the soot preform includes a phosphosilicate soot.

26. The method of claim 21 wherein the drying agent is a component of a drying gas mixture, and the concentration of POCl₃ in the drying gas mixture is between about 0.5% and about 4% by volume.

27. The method of claim 21 wherein the drying with POCl₃ dopes additional phosphorus into the soot preform.

28. An optical fiber made in accordance with the method of claim 1.

29. The optical fiber of claim 28 further comprising an attenuation of less than about 0.21 dB/km at a operating wavelength between about 1300 to about 1550 nm.

30. The optical fiber of claim 29 wherein said attenuation comprises about 0.195 dB/km or less.

31. A photomask glass made in accordance with method of claim 1.

32. A method of treating a preform comprising:
depositing soot on an outer surface of a core cane, thereby forming an overcladded core cane;
disposing the overcladded cane in a furnace;
charging the furnace with a gas mixture comprising at least one halide and at least one reducing agent; and
heating the furnace.

33. The method of claim 32 wherein the reducing agent comprises a compound that will preferentially react with an oxygen by-product of the following chemical equation
aMₓO_{y}+bX₂→cMᵢXⱼ+dO₂
wherein “a” is the stoichiometric coefficient of a compound desired to be reduced, M is a metal, hydrogen, or an alkali metal, “b” is the stoichiometric coefficient of a halide X, “c” is the stoichiometric coefficient of a reaction product of the reaction of said halide X and said M, “d” is the stoichiometric coefficient of an oxygen reaction by-product, and x, y, i, and j are numbers greater than 0.
